(19) United States
(12) Patent Application Publication
(10) Pub. No.: US 2026/0320444 A1
(43) Pub. Date: Oct. 15, 2026

(54) Systems and Methods for Variational, Geometry Regularized, Identity Preserving Cognitive State Evolution

(71) Applicant: Matthew Thornton, Houston, TX (US)

(72) Inventor: Matthew Thornton, Houston, TX (US)

(21) Appl. No.: 19/675,481

(22) Filed: May 13, 2026

Related U.S. Application Data
(63) Continuation of application No. 19/543,866, filed on Feb. 19, 2026.

(51) Int. Cl. G06N 5/04

(52) U.S. Cl. CPC G06N 5/04

(57) ABSTRACT

Systems and methods are disclosed for evolving an internal cognitive state using a variational principle incorporating geometric regularization, coherence constraints, and identity-preserving dynamics. A neural proposal mechanism generates a candidate update, and a governing operator corrects the proposal using geometric, constraint, and identity terms.

The corrected update is applied through a projection-ordered sequence consistent with an operator-separated cognitive architecture. The disclosed systems improve stability, reduce drift, mitigate hallucination, and provide bounded, predictable cognitive state evolution.

### CROSS-REFERENCE TO RELATED APPLICATIONS

This application is a continuation of U.S. application Ser. No. 19/543,866, filed Feb. 19, 2026, titled “Systems and Methods for an Operator Separated Cognitive Architecture for AI Reasoning”, the entirety of which is incorporated herein by reference.

### FIELD OF THE INVENTION

The present invention relates to systems and methods for evolving internal cognitive states in machine reasoning systems using variational principles, geometry-regularized dynamics, and identity-preserving constraints. The invention further relates to stability, drift suppression, hallucination mitigation, and controlled cognitive state evolution within operator-separated reasoning architectures.

### BACKGROUND

Machine reasoning systems often exhibit instability, drift, hallucination, divergence, and uncontrolled cognitive state evolution. These failure modes arise from unbounded update mechanisms, lack of identity preservation, absence of geometric regularization, and insufficient constraint enforcement.

Autoregressive and gradient-based systems may accumulate error, amplify noise, or diverge from coherent world-model structure.

There is a need for systems that govern cognitive state evolution through variational control, geometry-regularized dynamics, and identity-preserving mechanisms integrated within an operator-separated architecture.

### SUMMARY

In one aspect, the invention provides a system for evolving an internal cognitive state according to a variational principle that incorporates geometric regularization, coherence constraints, and identity-preserving dynamics. A neural proposal mechanism generates a candidate update to the internal state. A governing operator corrects the proposed update using a combination of geometric, constraint, and identity terms. The corrected update is applied through a projection-ordered sequence consistent with an operator-separated cognitive architecture comprising limitation, generation, collapse, and fixed-point operators.

In some embodiments, the disclosed systems improve stability of cognitive state evolution, reduce drift, mitigate hallucination, and prevent uncontrolled divergence. In some embodiments, the systems provide thermal stability, bounded computational cost, and predictable inference behavior. In some embodiments, the systems preserve identity across reasoning steps, enforce coherence with a world model, and regulate the geometry of the cognitive state space.

In some embodiments, the invention provides a variational action functional governing cognitive state evolution. In some embodiments, the invention provides a geometry-regularized update mechanism. In some embodiments, the invention provides an identity-preserving functional that constrains state evolution.

In some embodiments, the invention provides a coherence constraint that enforces consistency with external observations or a world model.

### DETAILED DESCRIPTION

In some embodiments, the system evolves an internal cognitive state s(t) according to an action functional of the form:

S[s]=∫dt[L_{g}eom(s(t), ds/dt)+λC(s(t), x(t)) +βd/dtSᵢd(s(t))].

The geometric term L_{g}eom regulates the evolution of the cognitive state according to a state-dependent metric. The coherence constraint C enforces consistency between the cognitive state and a world model or external observations. The identity-preserving functional Sᵢd constrains the evolution of the cognitive state to maintain continuity of identity across reasoning steps. The weighting coefficients A and B regulate the influence of the constraint and identity terms.

In some embodiments, the system includes a neural proposal mechanism configured to generate a proposed update to the cognitive state. In some embodiments, the system includes a governing operator configured to correct the proposed update using the geometric regularizer, the coherence constraint, and the identity-preserving functional. In some embodiments, the corrected update is applied to the cognitive state through a projection-ordered sequence.

In some embodiments, the system is integrated within an operator-separated cognitive architecture comprising a limitation operator, a generation operator, a collapse operator, and a fixed-point operator. In some embodiments, the governed update is applied between or within operator cycles. In some embodiments, the operator-separated architecture provides bounded cognitive state evolution, prevents uncontrolled divergence, and enforces structural separation of reasoning functions.

In some embodiments, the disclosed systems improve stability of cognitive state evolution by regulating the geometry of the state space, enforcing coherence constraints, and preserving identity. In some embodiments, the systems reduce drift by penalizing deviation from identity-preserving trajectories. In some embodiments, the systems mitigate hallucination by enforcing consistency with a world model. In some embodiments, the systems provide thermal stability and bounded computational cost by constraining the update mechanism and preventing runaway inference.

1. A system for evolving an internal cognitive state, comprising: a latent state vector; a projection operator configured to update the latent state; a geometric regularizer defined over a state-dependent metric; a coherence constraint enforcing consistency with a world model; an identity-preserving functional regulating continuity of the latent state; and a governing operator configured to combine the geometric regularizer, the coherence constraint, and the identity-preserving functional into a corrected update of the latent state.

2. The system of claim 1, wherein the state-dependent metric is learned or parameterized.

3. The system of claim 1, wherein the world model comprises a neural network.

4. The system of claim 1, further comprising a neural proposal mechanism configured to generate a proposed update to the latent state.

5. The system of claim 4, wherein the governing operator is configured to correct the proposed update using the geometric regularizer, the coherence constraint, and the identity-preserving functional.

6. The system of claim 1, wherein the identity-preserving functional comprises a divergence between the latent state and an identity reference state.

7. The system of claim 1, wherein the projection operator updates the latent state according to a variational principle.

8. The system of claim 1, wherein the corrected update reduces drift, improves stability, or mitigates hallucination during cognitive state evolution.

9. The system of claim 1, wherein the corrected update provides bounded computational cost or thermal stability.

10. The system of claim 1, wherein the system is integrated within an operator-separated cognitive architecture comprising a limitation operator, a generation operator, a collapse operator, and a fixed-point operator.

11. A method for evolving an internal cognitive state, comprising: receiving a latent state; generating a proposed update to the latent state using a neural proposal mechanism; computing a geometric regularization term based on a state-dependent metric; computing a coherence constraint enforcing consistency with a world model;
computing an identity-preserving functional regulating continuity of the latent state; combining the geometric regularization term, the coherence constraint, and the identity-preserving functional into a corrected update; and
applying the corrected update to the latent state.

12. The method of claim 11, wherein applying the corrected update comprises applying the update through a projection-ordered sequence.

13. The method of claim 11, wherein the corrected update reduces drift, mitigates hallucination, or prevents uncontrolled divergence.

14. The method of claim 11, wherein the corrected update provides thermal stability or bounded computational cost.

15. A non-transitory computer-readable medium storing instructions that, when executed by one or more processors, cause the processors to perform a method comprising:
generating a proposed update to a latent cognitive state;
computing a geometric regularization term; computing a coherence constraint enforcing consistency with a world model; computing an identity-preserving functional;
combining the geometric regularization term, the coherence constraint, and the identity-preserving functional into a corrected update; and applying the corrected update to the latent cognitive state.

16. The computer-readable medium of claim 15, wherein the instructions further cause the processors to apply the corrected update through a projection-ordered sequence.

17. The computer-readable medium of claim 15, wherein the corrected update reduces drift or mitigates hallucination.

18. The computer-readable medium of claim 15, wherein the corrected update provides thermal stability or bounded Computational cost.

19. The computer-readable medium of claim 15, wherein the instructions further cause the processors to enforce consistency between the latent cognitive state and a world model.

20. The computer-readable medium of claim 15, wherein the instructions further cause the processors to preserve identity across reasoning steps using the identity-preserving functional.
